(19) United States
(12) Patent Application Publication
(10) Pub. No.: US 2009/0208704 A1
(43) Pub. Date: Aug. 20, 2009

(54) ROOFING PRODUCT CONSTRUCTED FROM POLYMER /GYPSUM/ FIBERGLASS COMPOSITE MATERIAL

(76) Inventors: Ashish Diwanji, New Albany, OH (US); Leonard J. Adzima, Pickerington, OH (US); Paul R. Krumlauf, Thornville, OH (US)

Correspondence Address: OWENS CORNING, 2790 COLUMBUS ROAD, GRANVILLE, OH, 43023, US

(21) Appl. No.: 12/032,870

(22) Filed: Feb. 18, 2008

(51) Int. Cl. B05D 1/36; B32B 27/00

(52) U.S. Cl. 428/141; 427/407.1

(57) ABSTRACT

A roofing product is disclosed including a structural layer of composite material and a gel coat cover layer. The structural layer of composite material is formed by (a) a substantially homogeneous matrix of gypsum material and a polymer resin material and (b) wet-used chopped strand fibers. The wet-used chopped strand fibers are substantially filamentized with the substantially homogeneous matrix. In addition, a method for making a roofing product is disclosed.

### TECHNICAL FIELD AND INDUSTRIAL APPLICABILITY OF THE INVENTION

The present invention relates generally to fiberglass-reinforced products and, more particularly, to a urea-formaldehyde gypsum composite roofing product.

### BACKGROUND OF THE INVENTION

Interior and exterior construction boards, panels and surfaces with cores of plaster, cement, or hybrid materials, such as cement boards or gypsum boards, are used in a wide variety of indoor and outdoor structural applications. For example, the cement boards are used as a support surface for overlying materials such as wood siding, stucco, aluminum, brick, tile, stone aggregate and marble. Also cement and gypsum aggregates, themselves are used to form interior finishes such as solid surface countertops and fireplace surrounds. Also, the cement boards are used in exterior insulating systems, commercial roof deck systems, masonry applications and exterior curtain walls. In the manufacturing of such gypsum based materials, there is needed additional time and processing steps to ensure that the gypsum-based material is fully cured.

The present invention relates to a roofing product which may take the form of an individual molded shingle or a larger and more expansive roofing panel constructed from a unique composite material that exhibits high fire retardance, enhanced abuse resistance, superior structural properties, superior impact resistance and high water resistant properties.

### SUMMARY OF THE INVENTION

In accordance with the purposes of the present invention as described herein, a roofing product is provided. The roofing product comprises a layer of composite material formed from (1) (a) a substantially homogenous matrix of gypsum material and a polymer resin material and (b) wet-used chopped strand fibers, wherein the wet-used chopped strand fibers are substantially filamentized with the substantially homogeneous matrix and (2) a gel coat cover layer.

The composite material includes in parts by weight about 100 parts gypsum material, about 60 to about 75 parts polymer resin material, about 15 to about 25 parts wet-used chopped strand fibers and about 10 to about 30 parts water. In one particularly useful embodiment, the polymer resin material is urea formaldehyde resin.

More specifically describing the invention, the wet-used chopped strand fibers may comprise fiberglass fibers. The glass fibers may have about 0.1% of a sizing composition on exterior surfaces of the glass fibers. Typically the wet-used chopped strand fibers have lengths that range from between about ¼ inch to about 2 inches. Further, upon curing, the composite material has a Barcol Hardness number of at least about 40. Further, the composite material typically contains essentially no acrylic resin and essentially no melamine resin. In addition, the composite material may include at least one or more of: at least one catalyst for increasing the rate of cure of the polymer material, at least one catalyst for increasing hardness of the gypsum during cure, at least one additive for reducing the density of the composite material and at least one additive for improving water resistance of the composite material.

Still further describing the invention, a granulated surface may be provided on the gel coat layer. In addition or alternatively, the gel coat layer may be texturized to give an appearance of an architectural roofing element such as slate, wood shake, roofing tile or the like. Still further the roofing product may take the form of an individual shingle or a roofing panel. Such a roofing panel may be texturized to provide an appearance of multiple, overlapping shingles if desired.

In accordance with an additional aspect of the present invention the roofing product may include a second layer of composite material formed from (a) a substantially homogeneous matrix of gypsum material and a polymer resin material and (b) wet-used chopped strand fibers, wherein the wet-used chopped strand fibers are substantially filamentized with the substantially homogeneous matrix. Still further, a paint layer may be provided on the gel coat layer if desired.

In accordance with an additional aspect of the present invention a method is provided for forming a roofing element. The method comprises the steps of coating a mold with a polymer/gypsum composite liquid to form a gel coat layer, allowing the gel coat layer to at least partially set and adding a layer of composite material to the mold over the gel coat layer. That composite material comprises (a) a substantially homogeneous matrix of gypsum material and a polymer resin material and (b) wet-used chopped strand fibers, wherein the wet-used chopped strand fibers are substantially filamentized with a substantially homogeneous matrix. The method also includes the steps of allowing the gel coat layer and layer of composite material to at least partially set and removing the roofing element from the mold. In addition, the method may include the optional step of painting the roofing element following removal from the mold.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a perspective view of one possible embodiment of the roofing product of the present invention;

FIG. 2 is a side elevational view of another embodiment illustrating the layers of material provided in that embodiment;

FIG. 3 is a side elevational view similar to FIG. 2 but illustrating still another alternative embodiment of the present invention; and

FIG. 4 is a top plan view illustrating the texturing of overlapping individual shingles on a roofing panel constructed in accordance with the teachings of the present invention;

Reference will now be made in detail to the present preferred embodiments of the invention, examples of which are illustrated in the accompanying drawings.

### DETAILED DESCRIPTION OF THE PREFERRED EMBODIMENTS OF THE INVENTION

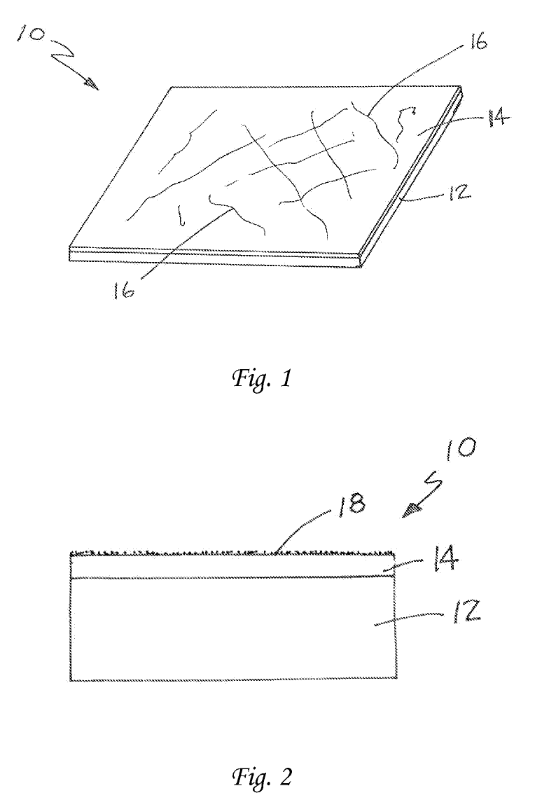

Reference is now made to FIG. 1 illustrating a first embodiment of the roofing product 10 of the present invention. The roofing product 10 comprises a structural layer of composite material formed from (a) a substantially homogeneous matrix of gypsum material and a polymer resin material and (b) wet-used chopped strand fibers, wherein the wet-used chopped strand fibers are substantially filamentized with the substantially homogeneous matrix. In addition, the roofing product 10 includes a gel coat cover layer 14 provided on top of the structural layer 12. Architectural roofing features 16 may be provided on the surface of the gel coat layer 14. Typically these features are molded or embossed into the gel coat cover layer 14. The architectural roofing features 16 may take substantially any appropriate form to mimic, for example, slate, wood shake and roofing tile. Of course, the architectural roofing features 16 may mimic substantially any material known to be useful in roofing a building or structure.

In the embodiment of the roofing product 10 illustrated in FIG. 2, the gel coat layer 14 on the structural layer 12 includes a textured surface that provides a granular appearance. Such a roofing product 10 may be cut to the length and width of an individual shingle in order to mimic the appearance of a standard asphalt shingle of a type currently popular in roofing homes and the like. The roofing product or shingle 10 may then be painted if desired. Spray painting is particularly effective to highlight the granular surface texturing.

Alternatively, the roofing product 10 may take the form of a roofing panel. The roofing panel 10 may include a basic structure as illustrated in FIG. 1 or 2 incorporating the structural layer 12 and the gel coat layer 14. As best illustrated in FIG. 4, the roofing panel 10 may also include an architectural feature 20 on the surface thereof. The illustrated architectural feature 20 comprises a series of lines or shading to mimic the appearance of multiple individual shingles installed on the roof of a building.

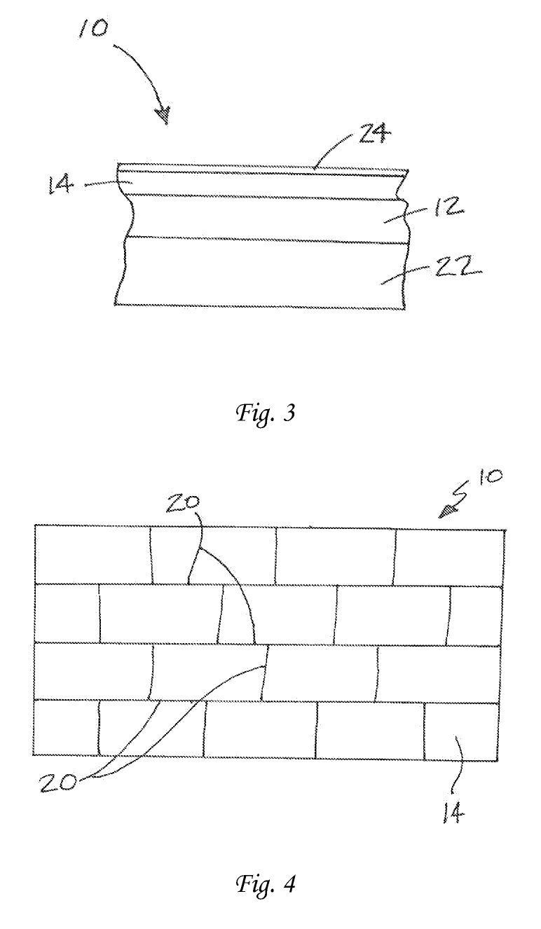

Yet another alternative embodiment of the roofing panel 10 is illustrated in FIG. 3. This roofing panel 10 includes first and second structural layers 12,22 that are laminated together. Each of the structural layers 12,22 is formed from a composite material having (a) a substantially homogeneous matrix of gypsum material and a polymer resin material as well as (b) wet-used chopped strand fibers. The wet-used chopped strand fibers are substantially filamentized with the substantially homogeneous matrix. In addition the roofing panel 10 includes a gel coat cover layer 14. As illustrated in FIG. 3 the cover layer 14 is covered by a layer of paint 24. In this way the roofing panel 10 can be made in a multitude of colors in order to suit customer taste. Further, after years of service, the appearance of the roofing panel 10 may be refreshed with a new coat of paint if desired. While the embodiment illustrated in FIG. 3 incorporates the paint layer 24, it should be appreciated that the roofing panel 10 may include in addition or alternatively an architectural feature 16 as described above with respect to the FIG. 1 embodiment, an architectural feature 20 (textured multiple shingles) as described and illustrated with regard to the FIG. 4 embodiment or a granulated surface layer 18 as described with respect to the FIG. 2 embodiment.

In any of the embodiments, the composite material that forms the structural layer 12 includes a gypsum material component that absorbs water, adds strength, is also a low-cost filler and provides fire resistance. The gypsum material is generally defined as a hydrous calcium sulfate material and can be, for example, one or more alpha, beta or synthetic gypsums.

The composite material also includes a polymer component that provides water resistance, strength and readily bonds to the wet-used chopped strand fibers. It is understood that in certain embodiments the polymer can be a suitable non-styrene polymer and that in certain embodiments the polymer comprises a urea-formaldehyde (UF) resin.

The composite material also includes a wet-used chopped strand material component that provides the composite with the desired reinforcement, strength, stiffness, low creep, good impact, dimensional stability, nail/screw compatibility, and bonding-to-polymer properties.

In certain embodiments, the wet-used chopped strand fibers are glass fibers that are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected. The chopped strands may contain hundreds or thousands of individual glass fibers. The collected chopped glass strands are then packaged in their wet condition as wet chopped fiber strands.

The wet-used chopped strand reinforcing fibers that are useful in the composite material may be any type of organic or inorganic fiber. In certain embodiments, it is desired that the wet-used chopped strand fibers provide good structural qualities as well as good acoustical and thermal properties to the composite material.

Non-limiting examples of suitable reinforcing fibers that may be used in the composite material include reinforcement glass fibers, wool glass fibers, natural fibers, cellulosic fibers, metal fibers, ceramic fibers, mineral fibers, carbon fibers, graphite fibers, nanofibers, or combinations thereof. The term “natural fiber” as used herein refers to plant fibers extracted from any part of a plant, including, but not limited to, the stem, seeds, leaves, roots, or bast. In the composite material, the reinforcing fibers may have the same or different lengths, diameters, and/or denier. In one embodiment, the reinforcing fibers are glass fibers, although other fibers can be used.

The wet-used chopped strand reinforcing fibers can have any suitable length that allows for good dispersion in the composite while also providing the desired structural properties. Non-limiting examples of such lengths include approximately about 1 to about 100 mm, and in certain embodiments, of from about 1 to about 10 mm, and in still other embodiments 10 to about 50 mm.

Additionally, in certain non-limiting examples, the wet-used chopped strand reinforcing fibers may have diameters of from about 8 to about 25 microns, and, in certain embodiments, can have diameters of from about 12 to about 18 microns. The wet-used chopped strand reinforcing fibers may have varying lengths, aspect ratios and diameters relative to each other within the composite material.

The wet-used chopped strand reinforcing fibers may be present in an amount of from about 1% to about 25%, by weight, of the total composite material, and, in certain embodiments, are present in an amount of from about 2% to about 8%, by weight. Also, in certain embodiments, the wet-used chopped strand fibers have a moisture content of from about 5 to about 25%, and, in certain embodiments, can have a moisture content of from about 10 to about 20%.

When wet-used chopped strand glass fibers are used as the reinforcing fibers, the glass fiber strands may be easily opened and dispersed within the substantially homogeneous matrix. The use of the wet-used chopped strand fiber causes little generation of undesirable static electricity due to the moisture present on the glass fibers.

The use of wet-used chopped strand glass fibers as the reinforcing fibers in a composite material provides a cost advantage over using the conventional dry-laid glass materials. For example, wet-used chopped strand glass fibers are less expensive to manufacture than dry chopped fibers. That is, the dry fibers require more processing and handling steps than the wet-used chopped strand fiber. For instance, the dry-use chopped fibers are typically formed, then dried, and finally packaged. The dry-use chopped fibers must then be “re-wetted” when being dispersed into a resin for the formation of any end product. Also, since the wet-used chopped strand fibers can be used “as is” the wet-used chopped strand fibers also save manufacturing time and costs.

In forming the composite material, bales of the wet-used chopped strand reinforcing fibers may be filamentized by any type of suitable opening system, such as bale opening systems, which are common in the industry. The opening system serves both to decouple the loosely clustered strands of the wet-used chopped strands and to enhance the fiber-to-fiber contact. That is, when the wet-used chopped strand fibers are filamentized (i.e., substantially evenly separated and well-distributed) within the gypsum urea formaldehyde mixture, substantially all of the wet-used chopped strand fibers are in direct contact with the substantially homogeneous matrix.

In an alternate embodiment, the wet-used chopped strand fibrous material can be formed into an impregnable material comprised of the wet-used chopped strand fibrous materials. In such embodiments, the wet-used chopped strands are substantially uniformly impregnated with the homogeneous gypsum urea formaldehyde mixture.

In certain embodiments, the present composite provides at least the advantage that there is no need to use any condensing system to remove water from the wet-used chopped strand fibers. In other particular embodiments, a suitable condensing system can be used to remove a desired amount of the free water (i.e., water that is external to the wet-used chopped strand reinforcing fibers). In such certain embodiments, some or substantially all of the water can be removed by the condensing system. It should be noted that the phrase “substantially all of the water,” as it is used herein, is meant to denote that all or nearly all of the free water is removed. The condensing system may be any drying or water removal device. Non-limiting examples include an air dryer, an oven, rollers, a suction pump, a heated drum dryer, an infrared heating source, a hot air blower, or a microwave-emitting source.

In one non-limiting example, after the wet-used chopped strand reinforcing fibers have passed through the condensing system, the fibers may be passed through another opening system, such as a bale opener as is described above, to further filamentize and separate the reinforcing fibers.

It is to be noted that during the formation of the wet-used chopped strand fibers, an aqueous sizing composition is applied to the fibers after they are drawn from the bushing. The sizing may be applied by application rollers or by spraying the sizing directly onto the fibers. Generally, the sizing composition protects the fibers from breakage during subsequent processing, helps to retard interfilament abrasion, and ensures the integrity of the strands of glass fibers, e.g., the interconnection of the glass filaments that form the strand or bundle of fibers. Thus, the wet-used chopped strand fibers have water entrapped within the strands themselves. These “wetted” wet-used chopped strand fibers are generally packaged together and then subsequently “opened, or filamentized.” The presence of water between and among the individual fibers greatly improves the processability in formulating the composite material.

More specifically, as the wet-used chopped strand fibers are being dispersed into the substantially homogeneous matrices, the viscosity of the “matrix/fibers” composite material being formed increases. Simultaneously, the gypsum is able to be interspersed among individual wet-used chopped strand fibers, and is able to react with the water present on the wet-used chopped strand fibers. Also occurring simultaneously is the curing of the polymer resin that is present in the matrix. The use of the wet-used chopped strand fibers (with their short length and interspersed water therebetween) allows for the hydration of the gypsum as the gypsum sets and the resin material cures. The wet-used chopped strand fibers provide a balance between ease of dispersion of the fibers within the homogeneous matrix and the greater amount of fibers that can be incorporated into the composite material.

The composite material may also include one or more additives. Non-limiting examples of some of these additives include: perlite or pumice as a density reducer, additional water to manage consistency and/or to help set the gypsum, a coupling agent such as a silane to improve bonding, a filler such as sand which is a low cost filler and provides additional fire resistance, a gypsum accelerator to control the hardening rate such as aluminum sulfate, and a polymer curative, such as ammonium sulfate, which speeds the UF resin cure rate.

In certain particular embodiments, the composite material can further include at least one or more of: at least one catalyst for increasing a rate of cure of the polymer resin material, at least one catalyst for increasing hardness of the gypsum during cure, at least one additive for reducing the density of the composite material, and at least one additive for improving water resistance of the composite material.

Also, it is to be noted that the composite material formulation can be optimized, depending on the end-use applications and that such factors that can be considered include, but are not limited to: type of gypsum; type of polymer; presence of fillers, density reducers, etc.; amount of water; consistency (i.e., ratio of gypsum to water), density, cost/lb.; cost/volume; viscosity; open, or cure, time; and use of extenders such as calcium carbonate or sand. These factors can be considered in order to make the lowest cost material but with the required performance characteristics. It is also to be noted that, from an environmental stand point, the composite material has low VOC's, and the components in the composite materials are generally safe, with only a small amount of free formaldehyde present in the UF resin.

The roofing product 10 may be formed by a relatively simple and efficient production method. That method includes the steps of: coating a mold with polymer/gypsum composite liquid to form a gel coat layer, allowing the gel coat layer to at least partially set and adding a layer of composite material to the mold over the gel coat layer. The composite material comprises (a) a substantially homogeneous matrix of gypsum material and a polymer resin material and (b) wet-used chopped strand fibers. The wet-used chopped strand fibers are substantially filamentized with the homogeneous matrix. In addition, the method includes the steps of allowing the gel coat layer and structural layer to at least partially set and removing the roofing product from the mold. The method may also include the optional step of painting the roofing product following removal from the mold.

The following example is presented to further illustrate the present invention.

### EXAMPLES

A molded shingle was made in accordance with the present invention. Initially a silicone or polyurethane mold was made from a standard or state of the art asphalt shingle. The shingle mold was coated with polymer/gypsum liquid in order to form a gel coat layer that prevents air bubbles and nonfills from appearing on the molded part surface. The polymer/gypsum liquid was made from the following formula:

A. alpha gypsum 300 g

B. VF-812 acrylic latex 150 g (available from Ball Consulting Ltd. of Ambridge, Pa.)

C. Water 10 g

D. L-77 wetting agent 0.1 g (available from Momentive Performance Materials).

The polymer/gypsum liquid was brushed onto the surface of the silicone mold. The wetting agent in the formula helped wet the hydrophobic mold surface. The polymer/gypsum liquid was then allowed to set for one hour to form the gel coat layer.

Next the composite material was prepared from the following formula:

A. alpha gypsum 1,039 g

B. Hexion 472 (UF resin) 710 g (available from Hexion Specialty Chemicals)

C. Ammonium sulfate 3 g

D. Water 50 g

E. Aluminum sulfate solution (10%) 10 g

F. wet-used chopped strands ¼ inch in length 100 g

G. L-77 wetting agent 0.4 g (available from Momentive Performance Materials)

First the Hexion 472 resin, water, aluminum sulfate solution and wetting agent were placed in a two gallon pail. The ammonium sulfate was combined with the gypsum and added to the liquid with stirring. The mix was blended for a few minutes until blended.

Next the glass was added to the mix and stirred with a spatula until the fiber was well dispersed. The thick mixture was then trawled onto the mold, spread around and rolled out with a two inch diameter serrated roller. The top of the mold was then covered with a piece of plastic sheet as a moisture barrier and the mold was allowed to set for four days. After setting the mold was carefully pulled away and the molded shingle was allowed to age for about 5 days. The roofing product or molded shingle was then spray painted. Specifically the top was painted green and the back was painted black. The glass reinforced polymer/gypsum shingle had a length of about 38.5 inches, a width of about 13 inches, a thickness of about 3/16 inch and a weight of approximately 4.25 pounds.

The formulas utilized in this example are strictly for purposes of illustration. Other ingredients like beta gypsum or perlite (density reducer) could be used. In addition, other additives and fillers (like CaCO₃) could be added to modify performance. Two solidification processes are going on with this system. One is the setting of the gypsum, the hydration reaction, and the second is the cross linking (curing) of the urea formaldehyde resin.

The foregoing description of the preferred embodiments of the present invention have been presented for purposes of illustration and description. It is not intended to be exhaustive or to limit the invention to the precise form disclosed. Obvious modifications or variations are possible in light of the above teachings.

For example, while the architectural roofing details 16,20 may be made by molding or embossing as described above, they could also be made by painting and shading the surface of the roofing product 10.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A roofing product, comprising:
a structural layer of composite material formed from (a) a substantially homogeneous matrix of gypsum material and a polymer resin material and (b) wet-used chopped strand fibers, wherein the wet-used chopped strand fibers are substantially filamentized with the substantially homogeneous matrix; and
a gel coat cover layer.

2. The roofing product of claim 1 wherein said composite material includes in parts by weight:
a.) about 100 parts gypsum material
b.) about 60 to about 75 parts polymer resin material;
c.) about 15 to about 25 parts wet-used chopped strand fibers; and
d.) about 10 to about 30 parts water.

3. The roofing product of claim 1, wherein said polymer resin material is urea formaldehyde resin.

4. The roofing product of claim 1, wherein the wet-used chopped strand fibers comprise fiberglass fibers.

5. The roofing product of claim 1, wherein wet-used chopped strand fibers comprise fiberglass fibers wherein the wet-used chopped strand fibers comprise glass fibers having about 0.1% of a sizing composition on exterior surfaces of the glass fibers.

6. The roofing product of claim 1, wherein the wet-used chopped strand fibers have lengths that ranges between about ¼ inch to about 2 inches.

7. The roofing product of claim 1, wherein, upon curing, the composite material has a Barcol Hardness number of at least about 40.

8. The roofing product of claim 1, wherein the composite material contains essentially no acrylic resin and essentially no melamine resin.

9. The roofing product of claim 1, further including at least one or more of: at least one catalyst for increasing a rate of cure of the polymer material, at least one catalyst for increasing hardness of the gypsum during cure, at least one additive for reducing the density of the composite material, and at least one additive for improving water resistance of the composite material.

10. The roofing product of claim 1, wherein said gel coat layer is textured to give an appearance of a granulated surface.

11. The roofing product of claim 1, wherein said gel coat layer is textured to give an appearance of an architectural roofing element.

12. The roofing product of claim 1, wherein said architectural roofing element is selected from a group consisting of slate, wood shake, roofing tile and multiple shingles.

13. The roofing product of claim 1, wherein said roofing product is an individual shingle.

14. The roofing product of claim 1, wherein said roofing product is a panel.

15. The roofing product of claim 14, wherein said roofing panel is textured to provide an appearance of multiple, overlapping shingles.

16. The roofing product of claim 1, further including a second layer of composite material formed from (a) a substantially homogeneous matrix of gypsum material and a polymer resin material and (b) wet-used chopped strand fibers, wherein the wet-used chopped strand fibers are substantially filamentized with the substantially homogeneous matrix.

17. The roofing product of claim 1, including a paint layer on said gel coat layer.

18. A method of forming a roofing product, comprising:
coating a mold with a polymer/gypsum composite liquid to form a gel coat layer;
allowing said gel coat layer to at least partially set;
adding a structural layer of composite material to said mold over said gel coat layer, said composite material comprising (a) a substantially homogeneous matrix of gypsum material and a polymer resin material and (b) wet-used chopped strand fibers, wherein the wet-used chopped strand fibers are substantially filamentized with the substantially homogeneous matrix;
allowing the gel coat layer and structural layer to at least partially set; and
removing roofing product from said mold.

19. The method of claim 18, including painting said roofing product following removal from said mold.
